(19) United States
(12) Patent Application Publication
(10) Pub. No.: US 2004/0181714 A1
(43) Pub. Date: Sep. 16, 2004

(54) Variable data rate bit error measurements using bit replication

(76) Inventor: Roger L. Jungerman, Petaluma, CA (US)

Correspondence Address: AGILENT TECHNOLOGIES, INC., Legal Department, DL429, Intellectual Property Administration, P.O. Box 7599, Loveland, CO, 80537-0599, US

(21) Appl. No.: 10/387,791

(22) Filed: Mar. 13, 2003

(51) Int. Cl. G06F 11/00

(52) U.S. Cl. 714/704

(57) ABSTRACT

From a digital pattern a signal is created, in which each bit of the original pattern is replicated n times. One replicated signal is transmitted through a device under test into an error detector module, where an identical replicated signal is generated and synchronized with the incoming signal using a clock. The synchronized signals are intercompared, errors are counted, and the bit error ratio (BER) of the incoming signal is calculated. In some embodiments, synchronizing includes delaying the clock over a maximum continuous range of one bit period and/or changing which bit of the incoming signal is compared with which bit of the second replicated signal. In some embodiments, clock delay and bit selection are combined to move the sampling point, obtaining BER as a function of sampling position across the digital pattern. Similarly, the sampling position is moved across bit periods individually to obtain a bit BER.

### TECHNICAL FIELD

This invention relates to determining the quality of digital communications systems and devices, and particularly to variable data rate bit error measurements using bit replication.

### BACKGROUND OF THE INVENTION

Bit Error Ratio measurement is a common way of determining the quality of a digital communications system. For a general purpose instrument, it is desirable to measure systems at a variety of input frequencies or bit rates. This complicates the system design by requiring all the digital and clock circuitry to operate over a wide frequency range. For example, a 10 Gb/s instrument might also be used to measure subchannels at 622 Mb/s.

Bit error ratio testing (BERT) is common in the art, and numerous commercial instruments perform this function in optical communications and other high speed digital applications such as computer backplanes. FIG. 1 is a block diagram schematically depicting prior art BERT 10. In BERT 10, known digital sequence 101 is produced by pattern generator (PG) 11. Digital data stream 102 is then captured by the BERT error detector (ED) 12, typically after passing through some device under test (DUT) 13. After synchronizing local sequence 103 generated in local data generator 14 of ED 12 and identical with known digital sequence 101 with incoming data stream 102 in decision circuit 17 of ED 12, compare module 15 in ED 12 compares synchronized incoming data stream 108 with local sequence 103, counts errors in synchronized incoming data stream 108, and displays Bit Error Ratio (BER) 104. Synchronization is required because of unknown delays in the propagation path between PG 11 and ED 12, and is typically performed using clock 105 generated in PG 11 transmitted independently to ED 12, where it is delayed or shifted in delay module 16 to generate delayed clock 106, which then clocks either local sequence 103 or incoming data stream 102 prior to comparing in compare module 15. If local sequence 103 is clocked by delayed clock 106, then synchronizing delayed clock 109 is transmitted to compare module 15.

There are various methods to synchronize ED pattern 103 to incoming data 102 from DUT 13. In the case of fixed patterns stored in RAM, the pattern in ED 12 is delayed relative to the incoming data until a match is obtained by trial and error. For PRBS patterns, the sequence is deterministic, the position in the sequence can be determined from a small number of bits (˜20-30), and subsequent bits in the sequence can be calculated from the initial values. For this reason, it is easier to synchronize to the PRBS pattern, but ED 12 can be synchronized in either case.

Often DUT 13 does not require a clock. PG 11 outputs a data stream (going to DUT 13) and also clock signal 105, synchronous with data 101, which is input independently to ED 12 concurrently with data 102 from DUT 13. In ED 12, clock signal 105 can be delayed continuously up to 1 bit period and this delayed clock 106 then goes to digital decision circuit 17. Decision circuit 17 is clocked by delayed clock 106. The clock delay is chosen by trial and error to minimize the error rate after the patterns are synchronized.

Slice voltage 107 determines in decision circuit 17 which voltage levels of incoming data stream 102 are interpreted as binary ones and which are interpreted as binary zeros. All incoming voltage levels above slice 107 are ones, and all incoming voltage levels below slice 107 are zeros. Synchronization and slice level 107 are generally adjusted by trial and error to obtain the lowest BER 104. This can be accomplished manually or algorithmically. Commercially available BERT hardware and its function are described for example in Agilent Technologies product data sheets for Parallel Bit Error Ratio Tester—ParBERT; ParBERT 81250 3.35G; InfiniBand Test Products; and 86130A BitAlyzer® Error Performance Analyzer.

Sampling point position in voltage is the setting of “slice” voltage 107. Incoming bits from DUT 13 into ED 12 are defined as being 0's if they are below slice voltage 107 and 1's if they are above. Changing slice voltage 107 far from the 50% point can cause received errors which will increase the BER.

Changing the sampling point in time refers to the delay between clock signal 105 and the point in time when the digital decision is made at decision circuit 17. Changing this delay can cause setup and hold time violations in decision circuit 17 or digital compare circuitry 15, resulting in errors. For minimum BER, the digital decision should be made somewhere near the center in time of the bit period from DUT 13. Clock 105 from PG 11 to ED 12 determines when decision circuit 17 and compare circuit 15 are clocked (at what point in time the digital decision is made).

For operation over a wide frequency range, data generator 14 and delay elements, for example delay 16, must operate over a similar range of frequencies. This greatly increases cost, since many commercial digital circuits are targeted at specific narrow frequency ranges and cannot be used over a broad frequency band. For example, voltage controlled oscillators (VCO) in multiplexers, delay locked loops (DLL) in data generator 14, and clock synthesizer VCO in delay module 16, are all band-limited unless great care and expense is taken.

It is possible to design a test instrument which measures only a narrow frequency range (as is done for example in functional testers), but then several independent modules are required to characterize a high speed serial signal together with its lower speed tributary signals. It would therefore be advantageous to develop a BERT system and method that retains the low cost of narrow-band hardware but provides the application flexibility to measure multiple bit rates over a wide range of frequencies.

### BRIEF SUMMARY OF THE INVENTION

The present invention is directed to a system and method in which a method of operating the basic digital circuitry over a narrow frequency range (e.g. 9.9-10.7 GHz) and then measuring systems at lower rates by bit replication is described. This simplifies the overall hardware design and reduces the cost. A method to retain the low cost of the narrow-band hardware but obtain the application flexibility to measure multiple rates is described.

According to the method, from a first digital pattern at a first frequency is created a subrate replicated digital pattern, such that each bit of the first digital pattern is replicated n number of consecutive times in the subrate replicated digital pattern and the subrate replicated digital pattern has an effective frequency 1/n times that of the first frequency. From the subrate replicated digital pattern are generated identical first and second replicated digital signals. The first replicated digital signal is transmitted through a device under test such that it degrades into an incoming replicated signal into an error detector module. The incoming replicated signal and the second replicated digital signal are then synchronized with a clock running at the first frequency. The two synchronized signals are intercompared, errors in the incoming replicated signal relative to the second replicated digital signal are counted, and the bit error ratio (BER) of the incoming replicated signal is calculated.

In some embodiments of the present invention, the first frequency clock is derived from the incoming replicated signal, whereas in some embodiments the clock is derived from the first replicated digital signal and then transmitted to the error detector module independently of the incoming replicated signal. In some embodiments, the synchronizing includes variably delaying the clock over a maximum continuous phase shift range of zero to one integer bit period at the first frequency and/or incrementally changing which bit number at the first frequency of the incoming replicated signal is being compared with a selected bit number of the second replicated digital signal. In some embodiments, the clock phase shift delay and bit comparison selection are combined to move the sampling point in time, thus obtaining the BER as a function of sampling position across the entire subrate digital pattern. Similarly, the sampling position can be moved across each individual bit period to obtain the bit BER of the subrate digital pattern.

In some embodiments disclosed herein, computer-executable software code stored to a computer-readable medium is provided. The computer-executable software code comprises code for creating from a first digital pattern at a first frequency a replicated digital pattern, such that each bit of the first digital pattern is replicated n number of consecutive times in the replicated digital pattern and such that the replicated digital pattern has an effective frequency 1/n times that of the first frequency. The code further comprises code for generating from the replicated digital pattern a first replicated digital signal and a second replicated digital signal identical with the first replicated digital signal, code for synchronizing the second replicated digital signal and a signal modified from the first replicated digital signal with a clock at the first frequency, and code for comparing the synchronized modified signal with the second replicated digital signal.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

For a more complete understanding of the present invention, reference is now made to the following descriptions taken in conjunction with the accompanying drawing, in which:

FIG. 1 is a block diagram schematically depicting a prior art bit error ratio testing arrangement;

FIG. 2 is a timing diagram illustrating the synchronization of a 2.5 Gb/s data stream constructed by replicating bits of a 10 Gb/s data stream, in accordance with embodiments of the present invention;

FIG. 3 is a timing diagram further illustrating synchronization of a 2.5 Gb/s data stream with a 10 Gb/s (10 GHz) clock; and

FIG. 4 is a flow diagram depicting a method of variable data rate bit error measurement using bit replication, in accordance with embodiments of the present invention.

GLOSSARY OF TERMS AND ACRONYMS

| | |
|---|---|
| DUT: | Device under test |
| Delay: | Method of synchronizing |
| Compare: | Look for differences between PG pattern and locally |
| | generated ED pattern; an indication of errors in the |
| | incoming PG data |
| Error Count: | Total number of miscompares (errors) |
| BER: | Bit error ratio; ratio of total number of errors to total |
| | number of incoming bits |
| Slice: | Method of changing the voltage threshold of the decision |
| | circuit; how large a voltage constitutes a “0” vs. a “1”; |
| | adjusted for minimum BER |
| FPGA: | Field programmable gate array |
| SONET: | Synchronous Optical Network (optical communications |
| | standard); various data rates, for example |
| | OC-48 2.488 Gb/s |
| | OC-12 622 Mb/s |
| Ethernet: | Data communications standard (LAN) 1.25 Gb/s |
| Fiber | Storage area network standard 1.06 Gb/s; |
| Channel: | 2 × Fiber Channel 2.12 Gb/s |
| PRBS: | Pseudo Random Bit Sequence; a deterministic series of |
| | bits which has a “white noise” pattern distribution (all bit |
| | combinations); this pattern is relatively easy to generate in |
| | digital hardware and it is also easy to synchronize the ED |
| | PRBS generator to the incoming PRBS bit stream from the |
| | PG. |
| Eye | A display produced by overlaying all bits on top of each |
| Diagram: | other; such a display is commonly produced with an |
| | oscilloscope triggered on the clock signal; there are 0--> 1 |
| | transitions (rising edges) and 1--> 0 transitions (falling |
| | edges) at both the left edge (data transitions immediately |
| | before the digital decision delay); and at the right edge |
| | (data transitions immediately after the digital decision |
| | delay). |
| Eye Crossing | Defined as the point in time when rising and falling edges |
| | of the eye diagram intersect. |
| NRZ | In NRZ nonreturn-to-zero codes a transmitted data bit |
| | occupies a full bit period. These codes are simple to |
| | generate and decode, but they possess no inherent error- |
| | monitoring or correcting capabilities and they have no self- |
| | clocking (timing) features. A long string of consecutive 1 |
| | bits can result in a baseline wander effect. |
| RZ | For RZ return-to-zero formats the pulse width is less than |
| | a full bit period. If an adequate bandwidth margin exists, |
| | each data bit can be encoded as two optical line code bits. |
| | In these codes a signal level transition occurs during either |
| | some or all of the bit periods to provide timing |
| | information. |

### DETAILED DESCRIPTION OF THE INVENTION

Referring again to FIG. 1, usually there are two separate similar digital circuits (PG 11 and ED 12). However, ED 12 has additional comparison circuitry and error counters. The patterns created in PG 11 and ED 12 are identical. After transmission, the ED pattern must be synchronized. There may be errors in transmission, such that the received pattern 102 at ED 12 does not match locally generated ED pattern 103.

A digital pattern is created which repeats each bit in the sequence an integer n number of times. Each bit is thus n times longer and the effective frequency is n times lower. The digital data generator must produce only 1/n of the total number of distinct bits that were required previously.

For example, a repeating 4-bit 10 Gb/s digital pattern (100 ps bit length) of 1001 1001 1001 1001 . . . (spaces added for clarity) can be converted to a 2.5 Gb/s pattern by replicating bits (again still of 100 ps bit length): 1111 0000 0000 1111 . . .

Considerable cost is saved, since the same narrow-band digital hardware can be used. In this way a standard commercial transceiver chip designed for 10 Gb/s SONET and forward error correction (FEC) rates, covering 9.9-12.5 GHz frequency range can be used to measure:

Replicate by 4:

3.125 Gb/s XAUI

2.5 Gb/s Infiniband or double Ethernet

2.488 Gb/s SONET

Replicate by 5:

2.12 Gb/s Double Fiber Channel

Replicate by 8:

1.25G Ethernet

Replicate by 10:

1.06 Gb/s Fiber Channel

Replicate by 16:

622 Mb/s SONET

The replicated signal is one where the original pattern is modified by copying each bit n times as described. Identical replicated patterns are loaded in PG 11 and ED 12. This replicated pattern must then be synchronized as before.

Clock 105 to ED 12 (at 10 Gb/s) can be delayed continuously up to 1 integer bit period at delay phase shifter 16. For longer delays, digital compare hardware 15 changes which bit from ED 12 is compared against what is arriving from DUT 13. This is part of the synchronization. For example, if there are 4.3 bits of total delay between digital pattern 102 coming into ED 12 from DUT 13 and digital pattern 103 generated in ED 12, the lowest error rate will be achieved by setting delay (phase shifter) 16 to 0.3 bit period (30 ps at 10 Gb/s with 100 ps bit period) while comparing bit 4 from ED pattern 103 with bit 0 from DUT transmitted pattern 102; bit 5 from ED 12 against bit 1 from DUT 13 and so forth. In practice, this is achieved by trying a few values of phase shifter delay and for each such value attempting to synchronize the bit comparison at compare module 15. If a low error rate is achieved (synchronization), then phase shifter delay 106 can be further optimized to achieve the lowest error rate.

Bit replication complicates this, because the digital hardware is clocking for example at 10 Gb/s, but it is required only that at least one of every four consecutive bits be received correctly. After this condition is achieved, then the “eye width” (the total variation in the sampling point position that can be achieved with a low error rate) can be determined by changing both phase shifter delay 106 (0-100 ps) and digital compare circuitry 15 (0-3 integer bits). This is referred to as “moving the sampling point”.

In error detector 12, it is necessary to synchronize to the replicated signal and then count errors. Typically, in error detector 12 it is desirable to measure this error rate as a function of the sampling point position in voltage and time. This complicates the error detection process, but it is still readily achieved by reprogramming modern FPGA digital generator/error detector logic (see for example Xilinx FPGA data sheet at web site http://www.xilinx.com/publications/products/v2pro/xc_v2pro43.htm), without adding hardware cost or complexity.

FIG. 2 is a timing diagram illustrating the synchronization of a 2.5 Gb/s data stream constructed by replicating bits of a 10 Gb/s data stream, in accordance with embodiments of the present invention. Sampling point 201 can be placed at the equivalent of the center of 400 ps eye 202 (at bit position 231) of 2.5 Gb/s data stream 203. The error rate for bit 2 of 10 Gb/s data stream 204 with the sampling point set to the maximum delay (right edge of 100 ps bit 242) is used. Equivalently, the error rate for bit 243 with the minimum delay (left edge of 100 ps bit 243) could be used. To sample across the full 400 ps of 2.5 Gb/s eye 202, separate error measurements of bits 241-244 of high speed (100 ps) bits 204 can be pieced together. The actual phase shifter delay 106 is varied over a range of only 0-100 ps, which simplifies the design and cost of phase shifter 16, while reducing calibration time and improving the accuracy.

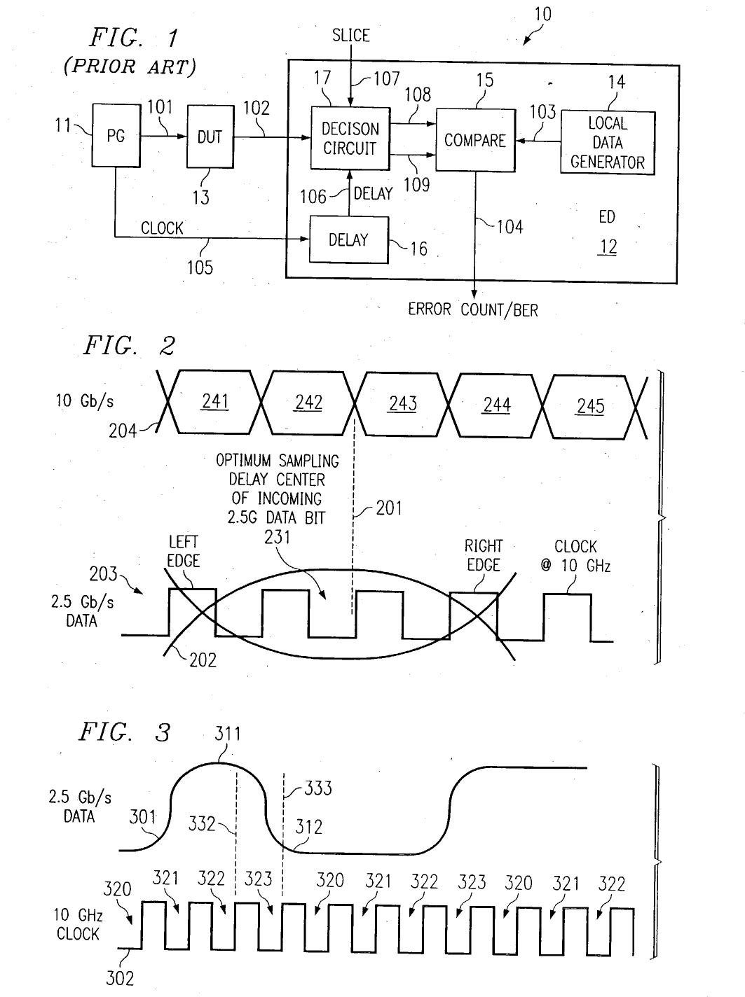

FIG. 3 is a timing diagram further illustrating synchronization of a 2.5 Gb/s data stream with a 10 Gb/s (10 GHz) clock. Incoming 2.5 Gb/s data stream 301 from DUT 13 is at a sub-rate of 10 GHz clock 302. In principle, each of the 4 sub-bits (320-323) at the 10 GHz clock rate should have the same value (zero or one). However, signal degradation due to slow transition times of the 2.5 Gb/s signal through DUT 13 causes only particular sub-bits to have the correct value. In FIG. 3, the first 2.5 Gb/s bit 311 of the sequence is a “1”. This is correctly measured for 10 GHz clock sub-bit 322 at sampling point 332. But sub-bit 323 at sampling point 333 incorrectly registers a “0” due to the slow transition time to the next bit 312 in the sequence (a “0”). By measuring the error rate separately for each of four sub-bits (320-323), the sub-bit with the minimum error rate can be determined empirically. Then the system margin can be determined by varying both the sub-bit error count that is evaluated (gives a coarse resolution of 0.25 bit period of 2.5 Gb/s data 301) and the fine delay 16 in ED 12 (gives 0-100 ps; or 0 to 0.25 bit resolution). As described above in connection with FIG. 2, actual phase shifter delay 106 (fine delay) is advantageously varied over a range of only 0-100 ps.

When synchronizing to the pattern, it is possible to determine which of the high-speed bits corresponds to which position in the replicated bit pattern. If the system being measured has very fast rise and fall times, this process is straight-forward. All bits in the high-speed pattern will be error-free, and incoming data pattern 102 is used to synchronize local data generator 14 in error detector 12 using conventional methods. Different methods are customarily used for memory (RAM based) patterns and PRBS patterns generated in the FPGA, and these are easily adapted for the replicated bit patterns. In general, however, finite rise/fall times and jitter in the incoming data will result in errors in the data at the edges of the eye. Thus, in general synchronization is achieved by constructing a pattern for matching which is of the form: XX1X XX0X XX0X XX1X, where X means “don't care”. The sampling point is placed at the left edge of the 100 ps eye (minimum delay) in this case. Once synchronization is achieved, other bits in the sequence (designated by X) can now be measured as before across the entire eye. In general, to measure total BER of the replicated data stream at all delay times, n separate BER totals are measured. The total elapsed time for the measurement is the same as for a standard error detector operating at the 1/n rate since each of the n individual bit BER totals can be measured simultaneously. Other specific bit patterns of a similar form can be constructed, since the foregoing example is intended to be illustrative only.

Bit BER (error rate for individual bit periods in the sequence) can be measured in a similar way. n separate bit BER totals are accumulated for each desired bit period in the replicated pattern.

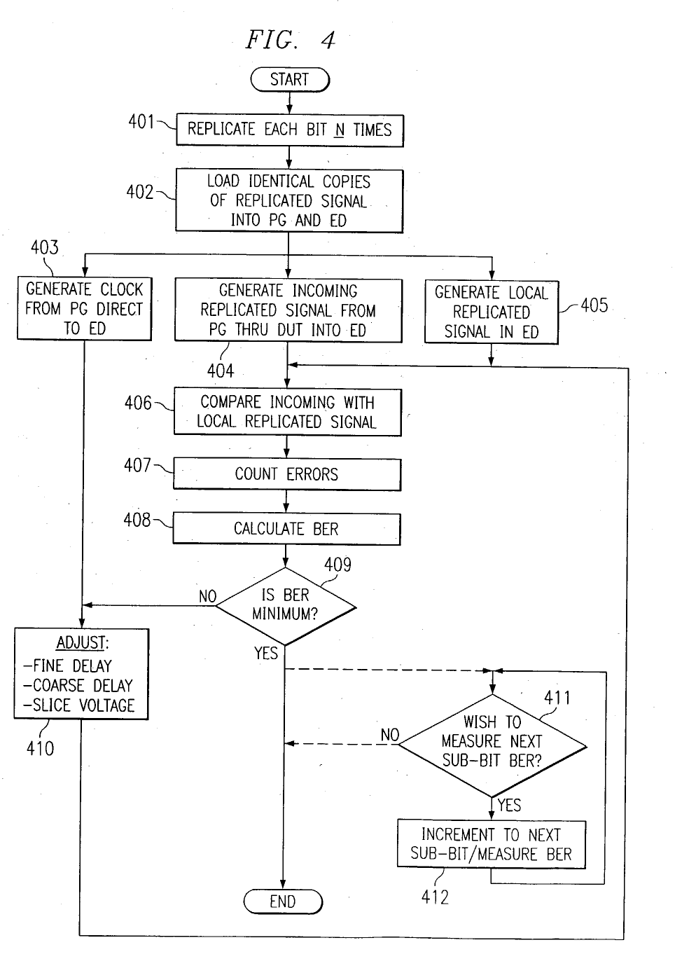

FIG. 4 is a flow diagram depicting a method of variable data rate bit error measurement using bit replication, in accordance with embodiments of the present invention. At step 401 a digital pattern is created which repeats each bit in the sequence an integer n number of times. Each bit is thus n times longer and the effective frequency is n times lower. The digital data generator must produce only 1/n of the total number of distinct bits that were required previously. At step 402 identical copies of the digital pattern created at step 401 are loaded into PG 11 and ED 12. At step 403 clock 105 synchronous with the replicated pattern is generated in PG 11 and transmitted directly to ED 12 or alternatively is recovered from incoming digital pattern 102 using a clock recovery circuit. Concurrently, at step 404 an incoming replicated digital pattern 102 generated in PG 11 is transmitted into ED 12 through DUT 13 where it is typically degraded, and at step 405 a local replicated digital pattern 103 is generated in ED 12. At step 406 in ED 12 local replicated digital pattern 103 is compared with incoming replicated digital pattern 102, errors are counted at step 407, and BER 104 is calculated at step 407.

At step 409 it is determined if BER 104 has reached a minimum value. If not, then at step 410 clock 105 is synchronized by adjusting phase shift fine delay 16, coarse delay by intercomparing bits of ED pattern 103 with different corresponding bits of incoming pattern 102, and adjusting slice voltage 107, as described above in connection with FIGS. 2 and 3, followed by another comparison and measurement iteration through steps 406-409. At step 409, if BER 104 has reached a minimum value, then the BER measurement process ends. Optionally, the measurement process can be extended at step 411 to increment to a next sub-bit and repeat the cycle as in steps 406-409 through step 412, to measure the next sub-bit BER.

In some embodiments, some or all of steps 401-412 depicted in FIG. 4 can be implemented using computer-executable software code stored to a computer-readable medium.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A bit error measurement method comprising:
creating from a first digital pattern at a first frequency a replicated digital pattern, such that each bit of said first digital pattern is replicated n number of consecutive times in said replicated digital pattern and such that said replicated digital pattern has an effective frequency 1/n times that of said first frequency;
generating from said replicated digital pattern a first replicated digital signal and a second replicated digital signal identical with said first replicated digital signal;
transmitting said first replicated digital signal through a device under test such that said first replicated digital signal undergoes modification to provide a modified signal;
receiving said modified signal;
synchronizing said modified signal and said second replicated digital signal with a clock at said first frequency; and
comparing said synchronized modified signal and said second replicated digital signal.

2. The method of claim 1 wherein said clock is derived from said modified signal.

3. The method of claim 1 wherein said clock is derived from said first replicated digital signal and is transmitted and received independently of said modified signal.

4. The method of claim 1 wherein said synchronizing comprises variably delaying said clock continuously over a maximum phase shift range of zero to one integer bit period at said first frequency.

5. The method of claim 1 further comprising counting errors in said modified signal relative to said second replicated digital signal.

6. The method of claim 5 further comprising calculating a bit error ratio (BER) of said modified signal.

7. The method of claim 6 wherein said synchronizing comprises incrementally changing the bit number at said first frequency of said modified signal that is being compared with a selected bit number at said first frequency of said second replicated digital signal

8. The method of claim 7 wherein said synchronizing comprises a combination of incrementally changing said bit number comparison and variably delaying said clock continuously over a maximum phase shift range of zero to one integer bit period at said first frequency.

9. The method of claim 8 further comprising measuring the error rate on said replicated digital pattern including moving the sampling point using combination of incrementally changing said bit number comparison and variably delaying said clock continuously over a maximum phase shift range of zero to one integer bit period at said first frequency.

10. The method of claim 9 further comprising obtaining total BER of said replicated digital pattern using said moving of the sampling point.

11. The method of claim 10 comprising obtaining bit BER of said replicated digital pattern using said moving of the sampling point.

12. The method of claim 11 wherein said synchronizing comprises optimization of said BER using a process of trial and error.

13. The method of claim 1 wherein said first frequency is in the range of 9.9 GHz to 12.5 GHz.

14. The method of claim 1 wherein said integer n is selected from the group of integers consisting of 4, 5, 8, 10, and 16.

15. The method of claim 1 wherein said first digital pattern occurs at a variable data rate.

16. The method of claim 1 wherein said bit error measurement is performed using narrow-band hardware.

17. The method of claim 1 wherein said receiving of said modified signal occurs at an error detector module.

18. Computer-executable software code stored to a computer-readable medium, said computer-executable software code comprising:
code for creating from a first digital pattern at a first frequency a replicated digital pattern, such that each bit of said first digital pattern is replicated n number of consecutive times in said replicated digital pattern and such that said replicated digital pattern has an effective frequency 1/n times that of said first frequency;
code for generating from said replicated digital pattern a first replicated digital signal and a second replicated digital signal identical with said first replicated digital signal;
code for synchronizing a signal modified from said second replicated digital signal and said first replicated digital signal with a clock at said first frequency; and
code for comparing said synchronized modified signal and said second replicated digital signal.

19. The computer-executable software code of claim 18, further comprising code for variably delaying said clock continuously over a maximum phase shift range of zero to one integer bit period at said first frequency.

20. The computer-executable software code of claim 18, further comprising code for counting errors in said modified signal relative to said second replicated digital signal.

21. The computer-executable software code of claim 20, further comprising code for calculating a bit error ratio (BER) of said modified signal.

22. The computer-executable software code of claim 21, further comprising code for incrementally changing the bit number at said first frequency of said modified signal that is being compared with a selected bit number at said first frequency of said second replicated digital signal

23. The computer-executable software code of claim 22, further comprising code for incrementally changing said bit number comparison and variably delaying said clock continuously over a maximum phase shift range of zero to one integer bit period at said first frequency.

24. The computer-executable software code of claim 23, further comprising code for measuring the error rate on said replicated digital pattern including moving the sampling point using combination of incrementally changing said bit number comparison and variably delaying said clock continuously over a maximum phase shift range of zero to one integer bit period at said first frequency.

25. The computer-executable software code of claim 24, further comprising code for obtaining total BER of said replicated digital pattern using said moving of the sampling point.

26. The computer-executable software code of claim 25, further comprising code for obtaining bit BER of said replicated digital pattern using said moving of the sampling point.

27. The computer-executable software code of claim 26, further comprising code for optimization of said BER using a process of trial and error.
